(19) United States
(12) Patent Application Publication
(10) Pub. No.: US 2024/0224135 A1
(43) Pub. Date: Jul. 4, 2024

(54) L1/L2 CENTRIC MOBILITY FOR SCELL(S)

(71) Applicant: TELEFONAKTIEBOLAGET LM ERICSSON (PUBL), Stockholm (SE)

(72) Inventors: ICARO LEONARDO DA SILVA, SOLNA (SE); PRADEEPA RAMACHANDRA, LINKÖPING (SE); HELKA-LIINA MÄÄTTÄNEN, ESPOO (FI)

(21) Appl. No.: 18/558,391

(22) PCT Filed: May 6, 2022
(86) PCT No.: PCT/IB2022/054233

§ 371 Date: Nov. 1, 2023

Related U.S. Application Data
(60) Provisional application No. 63/327,596, filed on Apr. 5, 2022.
(60) Provisional application No. 63/185,171, filed on May 6, 2021.

(51) Int. Cl. H04W 36/00; H04B 7/06

(52) U.S. Cl. CPC H04W 36/00692; H04B 7/06968

(57) ABSTRACT

There is provided a method performed by a user equipment (UE) configured in Carrier Aggregation for handling Layer 1(L1)/Layer 2 (L2) mobility for secondary cells associated with a cell group, the UE being configured with a first cell as a secondary cell in a first frequency. The method may comprise: receiving a configuration of at least one second cell in the first frequency, wherein the at least one second cell is a candidate to become the secondary cell: receiving a L1/L2 signaling, which comprises an indication to change the secondary cell from the first cell to the second cell: and changing the secondary cell in the first frequency from the first cell to the second cell.

### RELATED APPLICATIONS

This application claims the benefit of and priority to U.S. Provisional Patent Application No. 63/185,171, filed May 6, 2021, entitled “Codebook Subset Restriction for NR Type II Port-Selection Codebooks” and U.S. Provisional Patent Application No. 63/327,596, filed Apr. 5, 2022, entitled “L1/L2 centric mobility for SCell(s)”, the disclosure of these two provisional applications is hereby incorporated herein by reference in its entirety.

### FIELD

The present disclosure relates to wireless communications, and in particular, to Layer 1(L1)/Layer 2 (L2) mobility for secondary cells.

### BACKGROUND

### Beam Indications, Quasi-Co-Location (QCL) Source and Transmission Configuration Indicator (TCI) States

Several signals can be transmitted from the same base station antenna from different antenna ports. These signals can have the same large-scale properties, for instance in terms of Doppler shift/spread, average delay spread, or average delay, when measured at the receiver. These antenna ports are then said to be quasi co-located (QCL).

The network can then signal to the User Equipment (UE) that two antenna ports are QCL so that the UE interprets that signals from these will have some similar properties. If the UE knows that two antenna ports are QCL with respect to a certain parameter (e.g. Doppler spread), the UE can estimate that parameter based on a reference signal transmitted from one of the antenna ports and use that estimate when receiving another reference signal or physical channel from the other antenna port. Typically, the first antenna port is represented by a measurement reference signal such as a Channel State Information—Reference Signal (CSI-RS), known as source RS, and the second antenna port is a demodulation reference signal (DMRS), known as target RS, for Physical Downlink Shared Channel (PDSCH) or Physical Downlink Control Channel (PDCCH) reception.

QCL type D was introduced to facilitate beam management procedures with analog beamforming and is known as spatial QCL. Spatial QCL can be understood as if two transmitted antenna ports are spatially QCL, the UE can use the same receive (RX) beam to receive signals associated to them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to receive also this signal. Note that for beam management, the discussion mostly revolves around QCL Type D, but it is also necessary to convey a Type A QCL relation for the RSs to the UE, so that it can estimate all the relevant large-scale parameters. In other words, one could say that two signals are transmitted in the same direction or via the same downlink beams when these are QCL Type D. Hence, the network may give this relation between a channel to be decoded (e.g. PDCCH/PDSCH) and a signal that is known to be transmitted in a given direction that may be used as reference by the UE, like a CSI-RS, Synchronization Signal Block (SSB), etc.

Together with the concept of QLC source, there is the concept of a TCI state. Each of the M states in the list of TCI states can be interpreted as a list of M possible beams transmitted in the downlink from the network and/or a list of M possible transmission points (TRPs) used by the network to communicate with the UE. The M TCI states can also be interpreted as a combination of one or multiple beams transmitted from one or multiple TRPs. To introduce dynamics in beam and TRP selection/switching, the UE can be configured through Radio Resource Control (RRC) signaling with M TCI states (e.g. during connection setup, resume, reconfiguration, handovers, etc.), where M is up to 128 in frequency range 2 (FR2) for the purpose of PDSCH reception and up to 8 in FR1, depending on UE capability.

In terms of RRC signaling. TCI states are currently configured as part of the so-called CellGroupConfig, which is a Distributed Unit (DU) configuration (i.e. decided by the baseband unit) in a Central Unit (CU)-DU split architecture, and conveyed to the UE via for example an RRCResume (i.e. during transition from Inactive to Connected) or RRCReconfiguration (e.g. during handovers, intra-cell reconfigurations or transitions from Idle to Connected).

The TCI state configurations are signaled as part of the PDSCH configuration, which is configured per each downlink (DL) Bandwidth Part (BWP) of a Special Cell (SpCell), i.e. a Primary Cell (PCell) or a Primary Secondary Cell group (SCG) Cell (PSCell), where an SpCell can be comprised of one or more DL BWPs, or a Supplementary/Secondary Cell (SCell). FIG. 1 shows an exemplary structure of CellGroupConfigfor signalling (e.g. for the initial DL BWP case).

Each TCI state configuration contains a pointer, known as TCI State ID (TCI-StateId), which points to the TCI state. That pointer may be used, for example, to refer to a TCI configuration in a Control resource set (CORESET) configuration. In other words, the TCI configurations are provided in the PDSCH configuration in a given DL BWP. And, for PDCCH, the CORESET configuration contains a TCI state pointer to a configured TCI state in PDSCH.

Each TCI state contains the previously described QCL information, i.e. one or two source DL RS, where each source RS is associated with a QCL type. For example, a TCI state contains a pair of reference signals, each associated with a QCL type, e.g. two different CSI-RSs {CS1-RS1, CS1-RS2} is configured in the TCI state as {qcl-Type1, qcl-Type2}={Type A, Type D}. It means that the UE can derive the Doppler shift, Doppler spread, average delay, delay spread from CSI-RS1 and Spatial RX parameter (i.e. the RX beam to use) from CSI-RS2. In terms of RRC signaling, a TCI state is represented by an Information Element (IE) called TCI-State as shown in 3GPP TS 38.331.

In the TCI-State IE definition, there is a field called cell. According to the definition in 3GPP TS 38.331, the field called cell in the QCL configuration (i.e. cell field of IE ServCellIndex) is the UE's serving cell in which the RS that is QCL is being configured. If the field is absent, it applies to the serving cell in which the TCI-State is configured (i.e. the SpCell of the cell group, not an indexed SCell). The RS can be located on a serving cell other than the serving cell in which the TCI-State is configured only if the qel-Type is configured as type D (see TS 38.214 section 5.1.5). In other words, for a given spCellConfig, the RS for a given TCI state is associated to a serving cell in that cell group, which may be the PCell/PScell or an associated SCell(s). That is indicated by the field cell in the TCI state configuration. And if the field is absent, that refers to the cell where the TCI state is configured.

### L1/L2 Centric Mobility in Release 17 (Rel-17)

L1/L2 centric inter-cell mobility can be also referred to as L1-mobility, inter-Physical Cell Identity (PCI) TCI state change/update/modification, etc. While Rel-16 manages to offer some reduction in overhead and/or latency, high-speed vehicular scenarios (e.g. a UE traveling at high speed on highways) at FR2 require more aggressive reduction in latency and overhead—not only for intra-cell, but also for L1/L2 centric inter-cell mobility. Therefore, the work item description RP-193133 had the objective to enhance multi-beam operation, mainly targeting FR2 while also applicable to FR1.

Even though 3GPP has not decided how a L1/L2 inter-cell centric mobility should be standardized, the understanding for the purpose of this disclosure is that the UE receives a L1/L2 signaling (instead of RRC signaling) indicating a TCI state (e.g. for PDCCH) possibly associated to an SSB whose PCI is not necessarily the same as the PCI of the cell the UE has connected to e.g. via connection resume or connection establishment. In other words, the L1/L2-centric inter-cell mobility procedure can be interpreted as a beam management operation expanding the coverage of multiple SSBs associated to multiple PCIs (e.g. possibly associated to the same cell or different cells).

In Rel-16, the L1 mobility including multiple PCIs was already discussed but nothing was specified. RAN2 had a discussion on how to enable mPDCCH mTRP support in higher layers in an email (see 107 #39][NR] Multi PDCCH multi TRP impact to RAN2 (Ericsson)).

It was proposed to add a list of additional SSBs (including PCI) in ServingCellConfig; and to add a reference to one entry of that list in QCL-Info (only included if the reference is SSB).

It is likely that in Rel-17, one of the above may be considered as the baseline. Further, in the patent application WO2021/064494, multiple sets of SSBs were considered, where each set has its independent PCI configured for the UE, in serving cell configuration. An aspect here is that under a serving cell, a unique SSB can be indicated by the pair {SSB index and PCI} compared to Rel-15 where only a SSB index was used to address a unique SSB.

### Carrier Aggregation (CA) and Configuration of SCell(s)

In CA, two or more Component Carriers (CCs) are aggregated. A UE may simultaneously receive or transmit on one or multiple CCs depending on its capabilities. When CA is configured, the UE only has one RRC connection with the network. At RRC connection establishment/re-establishment/handover, one serving cell provides the Non-Access Stratum (NAS) mobility information and provides the security input. This cell is referred to as the Primary Cell (PCell). Depending on UE capabilities, Secondary Cells (SCells) can be configured to form together with the PCell a set of serving cells. The configured set of serving cells for a UE therefore always consists of one PCell and one or more SCells.

The reconfiguration/modification, addition, and removal of SCells can be performed via RRC signaling, e.g. RRC reconfiguration procedure, via RRCReconfiguration message. At intra-NR handover, for example, RRC can also add, remove, or reconfigure/modify SCell(s) for usage with the target PCell. When adding a new SCell, dedicated RRC signaling is used for sending all required system information of the SCell, i.e. while in connected mode, UEs need not acquire broadcast system information directly from the SCells.

When the UE transitions from IDLE to CONNECTED in a cell (e.g. the PCell), or from INACTIVE to CONNECTED state, the UE can be configured (e.g. in an RRCReconfiguration or an RRCResume message) with so-called SCells and are said to be in the same cell group (the Master Cell Group—MCG) as the PCell.

These SCells are configured as part of the MCG configuration, in the IE CellGroupConfig. They can be added in the sCellToAddModList where each SCell is configured

A similar reasoning can be applied in the case of SCells associated to the Secondary Cell Group (SCG). In other words, SCells can be added for the SCG when an SCG is being added to the UE. And, these SCells are said to be part of the SCG.

### SCell(s) State: Activation/Deactivation of an SCell (and Dormant SCell)

To enable reasonable UE battery consumption when CA is configured, an activation/deactivation mechanism of SCells is supported. When an SCell is deactivated, the UE does not need to receive the corresponding PDCCH or PDSCH, cannot transmit in the corresponding uplink, nor is it required to perform Channel Quality information (CQI) measurements. However, that does not prevent the need for performing Radio Resource Management (RRM) measurements for these SCells. Conversely, when an SCell is active, the UE shall receive PDSCH and PDCCH (if the UE is configured to monitor PDCCH from this SCell) and is expected to be able to perform CQI measurements.

When reconfiguring the set of serving cells:
SCells added to the set are initially activated or deactivated;
SCells which remain in the set (either unchanged or reconfigured) do not change their activation status (activated or deactivated).

At handover or connection resume from RRC_INACTIVE, SCells are activated or deactivated.

To enable reasonable UE battery consumption when Bandwidth Adaptation (BA) is configured, only one Uplink (UL) BWP for each uplink carrier and one DL BWP or only one DL/UL BWP pair can be active at a time in an active serving cell, all other BWPs that the UE is configured with being deactivated. On deactivated BWPs, the UE does not monitor the PDCCH, does not transmit on PUCCH, PRACH and UL-SCH. To enable fast SCell activation when CA is configured, one dormant BWP can be configured for an SCell. If the active BWP of the activated SCell is a dormant BWP, the UE stops monitoring PDCCH and transmitting Sounding Resource Signal (SRS)/PUSCH/PUCCH on the SCell but continues performing CSI measurements, Automatic Gain Control (AGC) and beam management, if configured. Downlink Control Information (DCI) is used to control entering/leaving the dormant BWP for one or more SCell(s) or one or more SCell group(s). The dormant BWP is one of the UE's dedicated BWPs configured by the network via dedicated RRC signalling. The SpCell and PUCCH SCell cannot be configured with a dormant BWP.

### SCell(s), TCI States and QCL Sources

Part of the SCell configuration is sCellConfigDedicated of IE ServingCellConfig., which is used to configure (add or modify) the UE with an Scell of an MCG or SCG. The parameters herein are mostly UE specific but partly also cell specific (e.g. in additionally configured bandwidth parts). As part of the initial BWP configuration (of IE BWP-DownlinkDedicated), the UE is configured with PDCCH and PDSCH configuration (for that BWP, and similar scheme for additional DL BWPs, if configured).

Within PDSCH-Config, for each BWP, there is a list of TCI states indicating a transmission configuration which includes QCL relationships between the DL RSs in one RS set and the PDSCH Demodulation Reference Signal (DMRS) ports.

Each TCI state in tci-StatesToAddModList is defined as described carlier. In brief, for a given SCell, the UE is configured per BWP with a list of TCI states. Each TCI state has a QCL source associated therewith (i.e. RS in the DL, e.g. an SSB of a given PCI). As the UE needs to know how to find that RS (e.g. PCI and SSB frequency/absolute radio-frequency channel number (ARFCN)), each QCL source configuration of a TCI state indicates the BWP the RS is transmitted (bwp-Id), and the UE's serving cell the RS is configured (e.g. that exact same SCell or another serving cell), and the RS index (e.g. SSB-index or CSI-RS index).

As in the case of an SpCell, based on the RRC-configured TCI states, the UE may receive a Media Access control (MAC) control element (CE) indicating which TCI states are to be activated/deactivated for UE-specific PDCCH. The network may indicate to the UE a TCI state for PDCCH reception for a CORESET of a Serving Cell (or a set of Serving Cells configured in simultaneousTCI-UpdateList1 or simultaneousTCI-UpdateList2) by sending the TCI State Indication for UE-specific PDCCH MAC CE (scc 6.1.3.15 in TS 38.321). If the MAC entity receives a TCI State Indication for UE-specific PDCCH MAC CE on a Serving Cell, the UE indicates to lower layers the information regarding the TCI State Indication for UE-specific PDCCH MAC CE.

The TCI State Indication for UE-specific PDCCH MAC CE is identified by a MAC subheader with Logical Channel ID (LCID). It has a fixed size of 16 bits with the following fields:
Serving Cell ID: This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells in the set simultaneousTCI-UpdateList1 or simultaneousTCI-UpdateList2, respectively:
CORESET ID: This field indicates a Control Resource Set identified with ControlResourceSetId as specified in TS 38.331 [5], for which the TCI State is being indicated. In case the value of the field is 0, the field refers to the Control Resource Set configured by controlResourceSetZero as specified in TS 38.331 [5]. The length of the field is 4 bits:
TCI State ID: This field indicates the TCI state identified by TCI-StateId as specified in TS 38.331[5] applicable to the Control Resource Set identified by CORESET ID field. If the field of CORESET ID is set to 0, this field indicates a TCI-StateId for a TCI state of the first 64 TCI-states configured by tci-States-ToAddModList and tci-States-ToReleaseList in the PDSCH-Config in the active BWP. If the field of CORESET ID is set to the other value than 0, this field indicates a TCI-StateId configured by tci-StatesPDCCH-ToAddList and tci-StatesPDCCH-ToReleaseList in the controlResourceSet identified by the indicated CORESET ID. The length of the field is 7 bits.

For example, FIG. 2 illustrates a TCI State indication for UE-specific PDCCH MAC CE. And Table 1 below shows an example of the codepoints corresponding to the LCID values.

TABLE 1

| Codepoint/Index | LCID values |
|---|---|
| 52 | TCI State Indication for UE-specific PDCCH |
| 53 | TCI States Activation/Deactivation for |
| | UE-specific PDSCH |

### SUMMARY

There currently exist certain challenge(s). With the introduction of L1/L2 centric mobility in Rel-17, the UE should be able to perform inter-cell mobility upon reception of a L1 or

L2 signaling. For example, a MAC CE indicating a TCI state having as QCL source a RS associated to a cell (not the current PCell and possibly in the frequency of the PCell), can possibly indicate (directly or indirectly) a new cell the UE needs to access.

3GPP RAN1 uses the terminology “serving cell” in the agreements for L1 mobility but details on how that would be applicable to SCells have not been discussed. One issue is that there is no notion of inter-cell mobility for SCells in 3GPP specifications and 3GPP systems (there is only PCell/PSCell mobility). And procedures for Scells such as SCell addition, modification and/or release all require an RRC Reconfiguration.

Another issue is that, for the PCell/PSCell, the UE is configured with a single SpCell per cell group with a given frequency (e.g. SSB frequency, point A frequency), for example: PCell for the MCG in SSB frequency f0, PSCell for the SCG in SSB frequency f1. Meanwhile, in the SCell case, the UE can be configured with multiple SCell(s) for a given cell group (one SCell per serving frequency that is not the SpCell frequency), for example, for the MCG: SCell(1) in SSB frequency f2, SCell(2) in SSB frequency f3 and for the SCG: SCell(3) in SSB frequency f4, SCell(4) in SSB frequency f5. In this example, the UE would have f0, f1, f2, f3, f4, f5 as serving frequencies and one serving cell per serving frequency.

One of the scenarios the disclosure addresses is shown in FIG. 3, where the UE is within the coverage area of a PCell (or a PSCell, more generically SpCell) but the coverage of SCell(s) changes as the UE moves. For example, let us assume that the UE is configured with a PCell-A which is in a low band (frequencies below 6 GHz) while the SCell-x is in high band (so that when the UE moves it remains in PCell coverage but not in Scell coverage, for frequency 2). Then, even if L1 mobility is possibly supported between PCells (assuming Pcell-B is also controlled by the same DU), the handling of SCell(s) would possibly require RRC signaling for SCell release and addition (Scell-x and cell-y and cell-z are in the same frequency and UEs cannot be configured with multiple SCells in the same frequency).

Certain aspects of the disclosure and their embodiments may provide solutions to these or other challenges.

The embodiments comprise a method implemented in a UE for handling the L1/L2 mobility for SCell(s) associated to a cell group, the UE being configured with a first cell as the SCell in a first frequency and being in CA. The method comprises: receiving configurations of at least a second cell in the first frequency, wherein the second cell is a candidate to be the SCell; receiving a L1/L2 signaling indicating a change of the secondary cell from the first cell to the second cell: and changing” the SCell in the first frequency from the first cell to the second cell.

In other words, the UE stops considering the first cell in the first frequency as the SCell and starts to consider the second cell as the SCell in the first frequency. This “start/stop consider as Scell” is a new procedure which is discussed in detail below.

The method also comprises configurations of cells in SCell frequencies (i.e. in serving frequencies that are not the SpCell frequency) that are candidates for L1-based mobility (such as the second cell) and different ways to refer to/identify these cells, e.g. an index associated to the cell group and/or the serving frequency.

The UE “changing” the SCell in the first frequency from the first cell to the second cell (in the first frequency) does not exist as a procedure in the NR or LTE specifications. Hence, actions corresponding to this “changing” may comprise any combinations of the following:
A) Set the SCell state of the first cell and/or the state of the second cell:
B) Handling of deactivation timer(s):
C) Handling of cell-specific configurations and UE-specific configurations.

The embodiments also comprise a method implemented in network node, e.g. gNB, or a DU-gNB, for handling the L1/L2 mobility for SCells associated to a cell group of a UE served by the NG-RAN, the network entity having configured the UE with a first cell as the SCell in a first frequency. The method comprises: transmitting to the UE configurations of at least a second cell in the first frequency, wherein the second cell is a candidate to be the SCell: and transmitting to the UE a L1/L2 signaling indicating a change of the SCell from the first cell to the second cell; and “changing” the SCell in the first frequency from the first cell to the second cell for that UE. In other words, as in the case of the UE, the network node also stops considering the first cell in the first frequency as the SCell and starts to consider the second cell as the SCell in the first frequency. The network node can also configure the UE with cells in SCell frequencies (i.e. in serving frequencies that are not the SpCell frequency) that are candidates for L1-based mobility (such as the second cell) and different ways to index/identify these cells, e.g. an index associated to the cell group and/or the serving frequency.

The network node “changing” the SCell in the first frequency from the first cell to the second cell (also in the first frequency) does not exist as a procedure in the NR or LTE specifications. Hence, actions corresponding to this “changing” may comprise one of the following of any combinations thereof:
A) Set the SCell state of the first cell and/or the state of the second cell:
B) Handling of deactivation timer(s):
C) Handling of cell-specific configurations and UE-specific configurations.

Certain embodiments may provide one or more of the following technical advantage(s).

With these embodiments, it is possible to configure multiple SCells in the same serving frequency and select a SCell based on a L1/L2 signaling, such as a MAC CE, without the need for SCell addition, modification and/or release as the UE moves towards the area of new SCells. For example, FIG. 4 illustrates such an example, where at different times, as the UE is moving, the UE considers different cells as the Scell in frequency 2.

### BRIEF DESCRIPTION OF THE DRAWINGS

Exemplary embodiments will be described in more detail with reference to the following figures, in which:

FIG. 1 illustrates an exemplary structure of CellGroupConfig.

FIG. 2 shows an example of a TCI state indication for UE-specific PDCCH MAC CE.

FIG. 3 illustrates an exemplary scenario where several Scells are configured for a UE, which moves around the coverage of these Scells.

FIG. 4 shows an example solution to the scenario of FIG. 3 according to an embodiment.

FIG. 5 shows an exemplary a set of Scells, associated with a nth cell group and configured for the UE.

FIG. 6 illustrates an example of a TCI state configuration for a cell.

FIG. 7 shows an exemplary MAC CE for TCI state configuration according to an embodiment.

FIG. 8 illustrates an example of a MAC PDU comprising two MAC subPDUs.

FIG. 9 shows an exemplary MAC CE for indicating activation/deactivation of a cell.

FIG. 10 shows an exemplary MAC CE for indicating activation/deactivation of a cell.

FIG. 11 illustrates a flow chart of a method in a UE, according to an embodiment.

FIG. 12 shows a flow chart of a method in a network node, according to an embodiment.

FIG. 13 shows an example of a communication system, according to an embodiment.

FIG. 14 shows a schematic diagram of a UE, according to an embodiment.

FIG. 15 shows a schematic diagram of a network node, according to an embodiment.

FIG. 16 illustrates a block diagram of a host.

FIG. 17 illustrates a block diagram illustrating a virtualization environment.

FIG. 18 shows a communication diagram of a host.

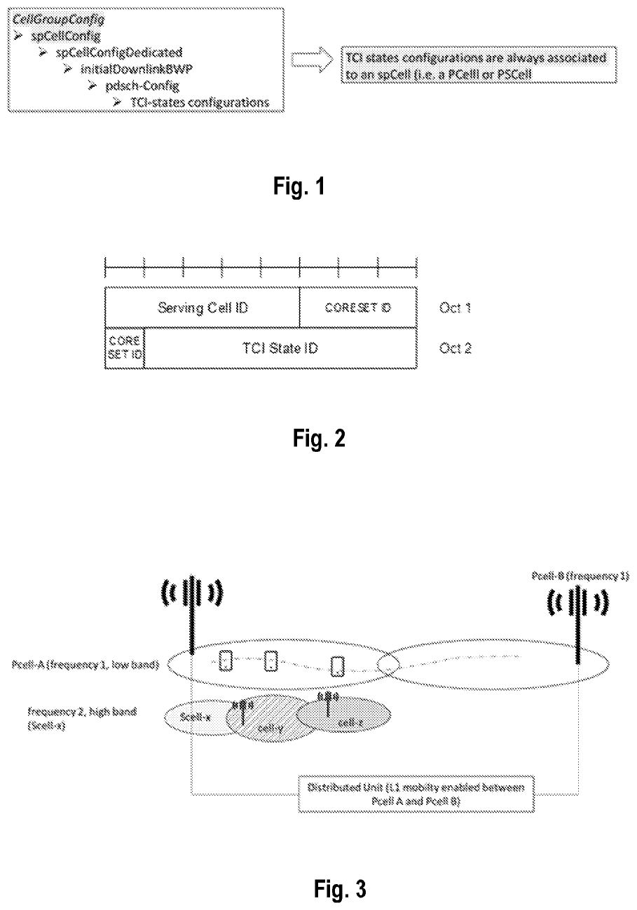

### DETAILED DESCRIPTION

Some of the embodiments contemplated herein will now be described more fully with reference to the accompanying drawings. Embodiments are provided by way of example to convey the scope of the subject matter to those skilled in the art.

The disclosure mentions “cells” or a “set of cells” or secondary cells with which the UE can be configured to perform L1/L2 centric mobility. These set of cells may be called a set of intra-frequency neighbour cells the UE can perform measurements on and can perform a change of SCells, or a set of intra-frequency non-serving cells or simply a set of non-serving cells (in addition to the serving cell). Or, the cells that the UE can use to perform L1 based mobility can be called candidate SCells, additional SCells, SCells, non-serving SCells, non-serving cells (configured SCells candidates for L1 based mobility), etc.

With regards to Abstract Syntax Notation one (ASN.1) encoding (for the examples showing signaling), consider TS 38.331 Rel-16 specifications for RRC as a reference for the omitted Information Elements (IEs) and fields in the messages and/or IEs that are proposed to be extended to implement the methods/embodiments herein disclosed.

The term “Secondary Cell” refers to a cell configured at the UE for CA, i.e. to be used as a component carrier. That term is used for NR (e.g. in TS 38.331) and in EUTRA (e.g. see TS 36.331). However, the embodiments herein are applicable to any type of cells with a different terminology but that may be configured at the UE for CA, or for a UE configured with CA, a cell providing additional radio resources on top of the Special Cell/PCell, PSCell or any sort of cells considered as a main cell or a higher hierarchy cell. The term “secondary serving frequency” refers to a carrier frequency (e.g. SSB frequency and/or Point A frequency, both as defined in TS 38.331) for a Secondary Cell, i.e. for a cell that is not an SpCell (i.e. not the PCell or the PSCell).

When the disclosure describes that the “UE receives” a message, e.g. a MAC CE, that can correspond to the UE receiving from a network node, a network function, such as a DU of a gNB in a Next Generation Radio Access Network, or a CU, or a node performing a baseband functionality.

The disclosure describes a solution in terms of TCI state(s) and the configuration of its QCL source, i.e., a RS associated to a cell (that is not a serving cell), which uses a terminology in the NR specifications (e.g. TS 38.211, TS 38.212, TS 38.213, TS 38.331, TS 38.321) but the disclosure should not be limited to that, as one of the aspects is that the UE is configured via higher layer signaling (e.g. RRC) with a beam indication (e.g. TCI state) associated to a physical channel (e.g. PDCCH) where the beams are associated to a cell that is not a secondary serving cell (i.e. not an SCell). Then, the UE receives a L1/L2 indication (e.g. a MAC CE) including an identifier of the beam indication (e.g. a TCI state identifier), where upon reception, the UE determines the beam indication and the cell associated to it: the UE determines that the cell of the indicated beam is in a serving frequency, but it's not a serving cell, and performs a change of serving cell in that serving frequency from the current serving cell to the cell associated to the indicated beam.

### Possible Solutions in 3GPP for L1/L2 Centric Mobility

The disclosure refers to the term “L1/L2 inter-cell centric mobility” which can be interchangeably used with the terms L1/L2 mobility, L1-mobility, L1 based mobility, L1/L2-centric inter-cell mobility or L1/L2 inter-cell mobility. The purpose of the L1/L2 inter-cell centric mobility is that the UE in RRC_CONNECTED is connected (i.e. being served by) to a serving cell (SpCell), considered to be the PCell e.g. after the UE performs connection setup, if transitioning from RRC IDLE to RRC_CONNECTED, or connection resume, transitioning from RRC_INACTIVE to RRC_CONNECTED, where the UE has a first PCI associated to that PCell, i.e. the PCI in ServingCellConfigCommon/SIB1 for the cell the UE was camping on when it performed the random access for the transition to RRC_CONNECTED. In the multi-beam scenario, a cell can be associated to multiple SSBs, and during a half-frame, different SSBs may be transmitted in different spatial directions (i.e. using different beams, spanning the coverage area of a cell).

Even though the term “L1/L2 inter-cell centric mobility” has the term “inter-cell”, an aspect is that a serving cell configuration has more than one physical cell identity (PCI) associated to it, and for that there are at least 2 approaches to create that association:

1) Intra-cell multi-PCI L1/L2 centric mobility: the same serving cell configuration is associated to more than one PCI (e.g. a TCI state configuration within ServingCellConfig can be associated to a PCI, which can be different from the PCI in ServingCellConfigCommon). For example, that means that the UE has an SCell associated to one or multiple PCIs, and, the UE can receive a L1/L2 signaling (e.g. a MAC CE, as the ones defined in TS 38.321) that indicates to the UE that the PCI of the Scell needs to be changed (e.g. from PCI-1 to PCI-2). That can be done by associating in an RRC signaling the SSB of PCI-2, configured as QCL source of a TCI state (indicated by TCI state Id-X) that is indicated in the MAC CE. Then, upon receiving that MAC CE with TCI State Id-X, the UE knows it needs to change to PCI-2, and perform actions associated to SCell(s), as described in the disclosure.

2) Inter-cell multi-PCI L1/L2 centric mobility: the UE has several cell configurations with respective PCIs associated but a TCI state may refer to other cell PCIs (e.g. other serving cell or, even a non-serving cell the UE can move to with L1/L2 centric mobility). For example, that means that the UE is configured with multiple cells e.g. SCells, each having their own PCI: and, the UE can receive a L1/L2 signaling (e.g. a MAC CE) that indicates to the UE that the SCell needs to be changed (e.g. from cell associated to PCI-1 to cell associated to PCI-2) in that given secondary serving frequency. That can be done by associating in an RRC signaling the SSB of cell associated to PCI-2, configured as QCL source of a TCI state (indicated by TCI state Id-X) that is indicated in the MAC CE. Then, upon receiving that MAC CE with TCI State Id-X, the UE knows it needs to change to the SCell associated to PCI-2, and perform actions associated to changing an SCell(s), as described in the disclosure.

When the disclosure describes a L1/L2 signaling for L1 mobility, it may refer to a “TCI State Indication for UE-specific PDCCH MAC CE” comprising one or multiple indications of TCI configurations (e.g. Serving Cell ID and/or a serving frequency ID), a CORESET ID, and a TCI State ID. That MAC CE can be identified by a MAC subheader with LCID as specified/as defined in TS 38.321.

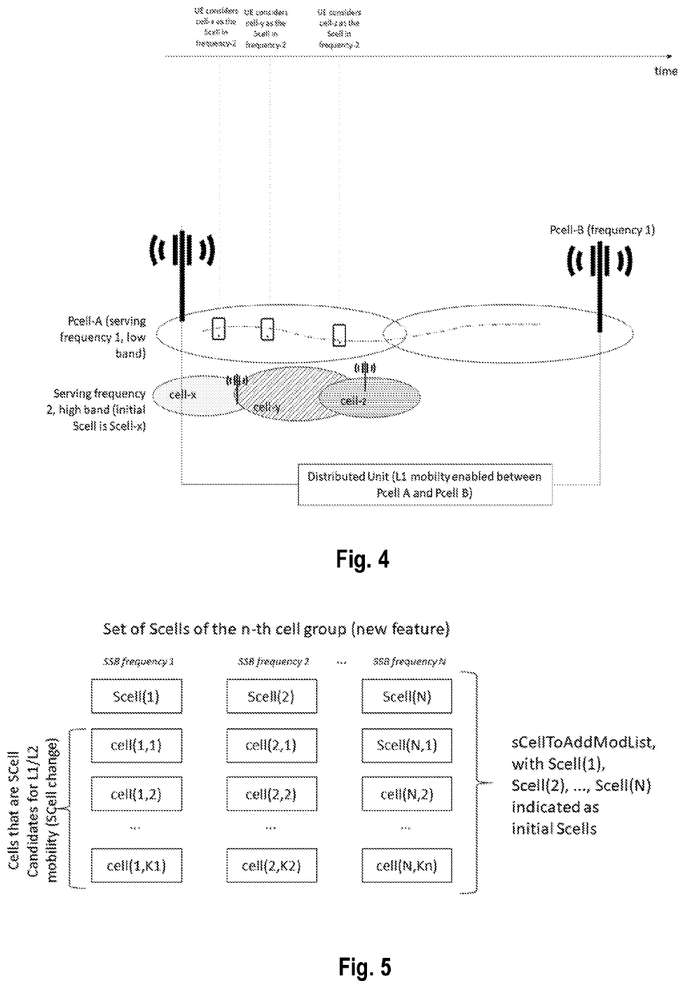

Now, a method at the UE will be described. For example, the UE may be configured in CA and move around as shown in the scenario of FIG. 4. As the UE moves around, the UE needs to change Scells (e.g. from cell-x, to cell-y to cell-z). First, the UE is configured with a first cell as the SCell in a first frequency. That means that the UE is configured with a secondary cell in the first frequency (which may be represented by an SSB frequency, defined by an ARFCN and/or a point A frequency, as defined in TS 38.331). For example, the UE may receive that SCell configuration as part of the MCG or the SCG configuration, in the IE CellGroupConfig. Then, the UE receives configurations of at least a candidate second cell in the first frequency (e.g. frequency 2). The candidate second cells are candidate to be the SCell via L1/L2 centric mobility. After receiving a L1/L2 signalling (L1 mobility), which comprises an indication of a candidate second cell for the Scell, the UE changes the Scell to the candidate second cell and takes some actions accordingly. These different steps will be described in more detail now.

There are different ways on how to configure cells in SCell frequencies (i.e. in serving frequencies that are not the SpCell frequency), including the first cell and the candidate second cells for L1-based mobility and different ways to refer or to identify these cells, e.g. via an index associated to the cell group and/or the serving frequency. For example, the cells for Scell candidates can be configured as a common list for all SCell serving frequencies or they can be configured as per serving frequency.

A) Common list for cells in all SCell serving frequencies.

In one example, the UE is configured with multiple cell(s) (e.g. cell(1,1), cell(1,K1)) in the same serving frequency (called first frequency, e.g. frequency 1), and for one of the cells in that frequency, it is indicated which one is the so-called initial SCell (or first Scell). That is needed so that the UE is aware of which of the cells configured in that serving frequency, e.g. cell(1,k1), is to be initially considered as the SCell in that serving frequency, to be considered when the UE receives a RRC message, e.g. RRCReconfiguration. This is important as the method assumes that the UE can be configured with multiple cell configurations for a given serving frequency (though a single cell may be the SCell in that serving frequency).

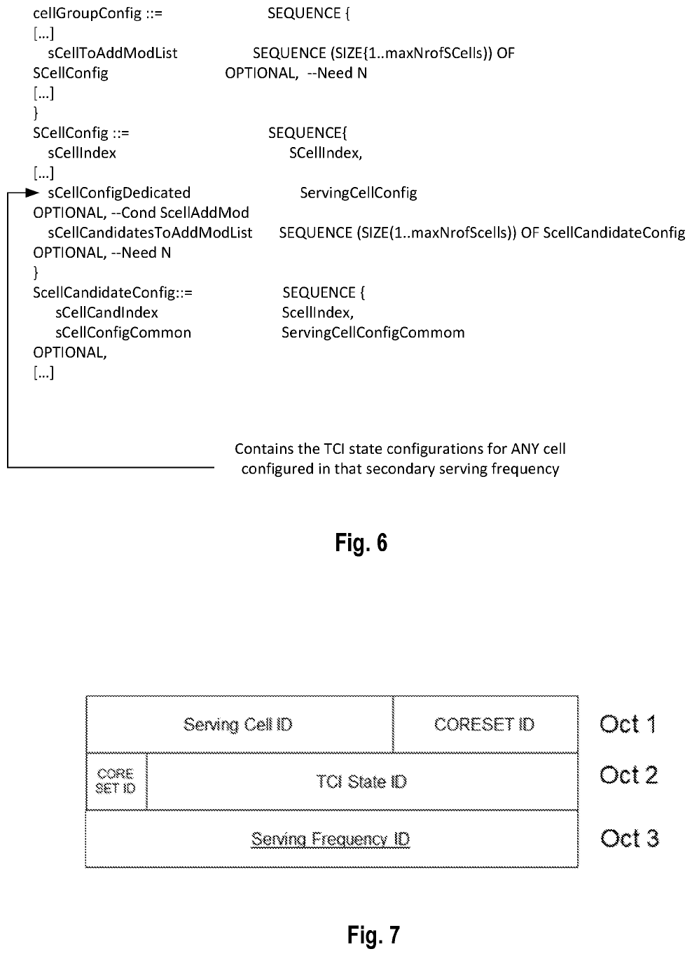

In one example, a list, set or group (e.g. the list sCellToAddModList in CellGroupConfig) defines more than one cell per serving frequency. FIG. 5 illustrates a set of Scells for a cell group. If there can only be one cell considered as SCell per frequency, the UE can receive a parameter in the RRC signaling to indicate that a given cell is to be considered the SCell in that frequency, when the UE receives the RRC message (e.g. the parameter can be initialSCell that may be a Boolean IE, or its inclusion could indicate that the cell where that is configured is the initial SCell in that frequency). If cells (e.g. cell(1,1), . . . , cell(1,K1)) are configured in sCellToAddModList, they are configured as if they would all be SCell(s), though the initial SCell (per serving frequency) is the one indicated. In this case, each cell in the first frequency is identified/indexed by its cell index/identifier (e.g. sCellIndex of IE SCellIndex) and a configuration of a candidate cell can be later identified by that index. An example in ANS. 1 is shown below:

| | |
|---|---|
| CellGroupConfig ::= | SEQUENCE { |
| [...] | |
| sCellToAddModList | SEQUENCE (SIZE (1..maxNrofSCells) ) OF SCellConfig |
| OPTIONAL, -- Need N | |
| [...] | |
| } | |
| SCellConfig ::= | SEQUENCE { |
| [...] | |
| initialSCell | BOOLEAN |
| } | |

The cell index (e.g. sCellIndex of IE SCellIndex) can be used as the indication that the configured cell is to be considered the initial SCell in that associated frequency. In one example, the UE considers to be the initial SCell the cell with the smallest cell index/identifier among the cells within the same frequency. For example, if the UE is configured with cells in secondary frequencies as follows: [cell(1,f1), cell(2,f1), cell(3,f1), cell(4,f2), cell(5,f2), cell(6,f3)], with the cell indexes/identifiers/identities being respectively: 1, 2, 3, 4, 5, 6 (and fk refers to a frequency k), the UE considers as the initial SCell(s) in each fk frequency the following:
Initial Scell in serving frequency f1 is the cell whose cell index=1 (smallest index in that frequency): consequently, the cells whose indexes are equal to 2 and 3 are candidates for L1 mobility in f1:
Initial Scell in serving frequency f2 is the cell whose cell index=4: consequently, the cells whose indexes is equal to 5 is a candidate for L1 mobility in f2:
Initial Scell in serving frequency f3 is the cell whose cell index-6: no other candidates are configured for L1 mobility in f3.

The benefit of this example, compared to the previous one, is that one does not need to introduce an additional signaling (e.g. no need to introduce the parameter initialSCell), though one needs to re-signify the cell indexes used in the RRC signaling.

It should be noted that as candidate cells are configured as SCells, they may in principle have the same configurations of an SCell. However, the configuration of candidate SCell(s) may be limited to cell-specific configuration(s), such as information in the IE ServingCellConfigCommon, like the PCI. The UE can receive an indication to modify or release a candidate cell for L1 mobility in the first frequency as it may receive for an SCell.

In the examples, the cell index of the second cell (configured as an SCell candidate for L1 mobility) can be used to indicate to the UE that a RS configured as QCL of a TCI state is of the second cell. An example is shown below for the configuration of a TCI state whose tci-StateId=3, and the cell index cell=4 (to indicate that the RS refers to the candidate cell whose sCellIndex is set=4):

| | |
|---|---|
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| . . . | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| . . . | |
| } | |
| -- TAG-TCI-STATE-STOP | |
| -- ASN1STOP | |

cell
The UE's serving cell (or candidate cell for L1 mobility) in which the referenceSignal is configured. If the field is absent, it applies to the serving cell in which the TCI-State is configured. The RS can be located on a serving cell other than the serving cell in which the TCI-State is configured only if the qcl-Type is configured as typeC or typeD. See TS 38.214 [19] clause 5.1.5.

Assuming that the TCI state configured above is within the SCellConfig for which index is sCellIndex and was set to 2, it means that the UE knows that it needs to look at that TCI state if it receives a MAC CE whose Serving Cell ID is equals to 2. Then, upon reception of a MAC CE indicating tci-StateId=3, the UE determines that the RS configured (e.g. SSB 12) is for cell index cell=4, one of the configured candidates for L1 mobility, and performs the change from its current SCell (e.g. cell whose sCellIndex=2) to the candidate cell whose cell index is sCellIndex=4.

Further details about this SCell changing operation is provided later in this disclosure. In a mobility scenario (reconfiguration with sync, handover, PSCell change), the initial SCell (within the list of candidates) can be set by a target network node (e.g. a target gNodeB) in response to a Handover Request message.

### B) List of Cells Per Serving Frequency (for an SCell).

In one example, the UE is configured with one SCell in the first frequency that is considered to be the initial SCell when the UE receives the RRC signalling. Additional cells (e.g. within each SCellConfig) that are configured can be considered as candidate cells for L1 mobility in that frequency. Each candidate may become an SCell via L1/L2 signaling (MAC CE). These candidates configured in a new list within each SCellConfig (e.g. sCellCandidatesToAddModList), e.g. in the SCellConfig for the first frequency. Note that SCellConfig becomes like a configuration per frequency, not just per SCell. The configurations of the initial SCell are the configurations within SCellConfig that are not within the list/set of configurations for the additional cell (i.e. not within sCellCandidatesToAddModList), such as the UE-specific configuration, SCellConfigCommon for that initial SCell, etc.

A first index/identifier can be used as a serving frequency index (e.g. the sCellIndex in SCellConfig) and, at least each additional candidate for L1 mobility in that serving frequency is further identified by a second index (to identify a candidate cell in that first frequency e.g. sCellCandIndex). The second index is important in case the UE needs to identify a candidate cell for L1 mobility in the first frequency, e.g. the second index/identifier can be used (together with the first index, for the serving frequency) to indicate that a RS configured as QCL source for a TCI state is a RS of the candidate cell with the second index. An example of this signalling is shown below:

| | |
|---|---|
| CellGroupConfig ::= | SEQUENCE { |
| [...] | |
| sCellToAddModList | SEQUENCE (SIZE (1..maxNrofSCells) ) OF SCellConfig |
| OPTIONAL, -- Need N | |
| [...] | |
| } | |
| SCellConfig ::= | SEQUENCE { |
| sCellIndex | SCellIndex, |
| [...] | |
| sCellCandidatesToAddModList | SEQUENCE (SIZE (1..maxNrofSCells) ) OF SCellCandidateConfig |
| OPTIONAL, -- Need N | |
| } | |
| SCellCandidateConfig::= | SEQUENCE { |
| sCellCandIndex | SCellIndex, |
| [...] | |
| } | |

The benefit of this example is that it does not change the legacy signaling and the meaning of the parameters for secondary serving frequencies where there is only one cell (that is the SCell), until the UE is re-configured. If there are no candidates for L1 mobility in a given secondary serving frequency, the first index/identifier is both a serving frequency index and a serving cell index.

In some examples, the second index/identifier, is used by the UE as an indication that a RS configured as QCL of a TCI state is of the second cell, i.e. a candidate cell to be an SCell that is not the initial SCell. That can be combined with the first index/identifier that indicates the serving frequency of the second cell.

An example is shown below for the configuration of a TCI state whose tci-StateId=3, the cell index cell=4, and the sCellCandIndex=2 (the candidate cell where that TCI state is configured):

| | |
|---|---|
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| . . . | |
| } | |
| QCL-Info ::= | SEQUENCE { |
| cell | ServCellIndex |
| OPTIONAL, -- Need R | |
| sCellCandIndex | SCellIndex, |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, typeD}, |
| . . . | |
| } | |
| -- TAG-TCI-STATE-STOP | |
| -- ASN1STOP | |

cell
The UE's serving cell in which the referenceSignal is configured (except if multiple candidates are configured for L1 mobility for an SCell). If the field is absent, it applies to the serving cell in which the TCI-State is configured. The RS can be located on a serving cell other than the serving cell in which the TCI-State is configured only if the qcl-Type is configured as typeC or typeD. See TS 38.214 [19] clause 5.1.5. If more than one cell is configured as candidate for L1 mobility, that indicates the serving frequency, while the sCellCandIndex indicates the candidate cell within that serving frequency. If more than one cell is configured as candidate for L1 mobility, and sCellCandIndex is absent, the RS is associated to the initial SCell in the serving frequency indicated by cell.

Under the assumption that the TCI states configuration are part of the initial SCell configuration, i.e. within SCellConfig, upon reception of the MAC CE including the Serving Cell ID, the UE knows that the TCI state to look at is within the initial SCell configuration for the SCell in the serving frequency indicated by the received Serving Cell ID. Hence, the UE receives a MAC CE including Serving Cell ID=2 and TCI state ID=3, and it determines the new QCL source and new SCell based on the stored RRC configuration for the serving frequency whose first index/identifier=2 (i.e. sCellCandIndex-2) and tci-StateId=3 (for the indicated CORESET).

Despite the new nested RRC structure for the serving frequency, the initial SCell and the candidate cells to be SCell via L1 mobility, the MAC CE only needs to indicate a TCI state that the UE is configured with and the indication of the SCell serving frequency. In summary, under this assumption, the Serving Cell ID in the MAC CE indicates the identity of the initial Serving Cell for which the MAC CE applies, which contains the UE-specific configurations (including the TCI state configurations) for that UE for any cell in that serving frequency. FIG. 6 illustrates such configurations, as an example.

In this example, there may be various alternatives for what is included in the configuration of the initial SCell (i.e. the IEs and parameters outside the list sCellCandidatesToAddModList) compared to what is included as configurations of each candidate cell to be an SCell via L1 mobility (i.e. the configuration included in each instance of SCellCandidateConfig).

For example, the configuration of candidate cells for L1 mobility to be changed to SCell(s) may be limited to cell-specific configuration(s), such as information in the IE ServingCellConfigCommon, including the PCI. An example is shown below:

| | |
|---|---|
| CellGroupConfig ::= | SEQUENCE { |
| [...] | |
| sCellToAddModList | SEQUENCE (SIZE (1..maxNrofSCells) ) OF SCellConfig |
| OPTIONAL, -- Need N | |
| [...] | |
| } | |
| SCellConfig ::= | SEQUENCE { |
| sCellIndex | SCellIndex, |
| [...] | |
| sCellCandidatesToAddModList | SEQUENCE (SIZE (1..maxNrofSCells) ) OF SCellCandidateConfig |
| OPTIONAL, -- Need N | |
| } | |
| SCellCandidateConfig::= | SEQUENCE { |
| sCellCandIndex | SCellIndex, |
| sCellConfigCommon | ServingCellConfigCommon |
| OPTIONAL, -- Cond SCellAdd | |
| [...] | |
| } | |

In another example, the configuration of candidate cells for L1 mobility to be changed to SCell(s) may include UE-specific configurations, such as information in the IE ServingCellConfig, like TCI state configurations as shown below:

| | |
|---|---|
| CellGroupConfig ::= | SEQUENCE { |
| [...] | |
| sCellToAddModList | SEQUENCE (SIZE (1..maxNrofSCells) ) OF SCellConfig |
| OPTIONAL, -- Need N | |
| [...] | |
| } | |
| SCellConfig ::= | SEQUENCE { |
| sCellIndex | SCellIndex, |
| [...] | |
| sCellCandidatesToAddModList | SEQUENCE (SIZE (1..maxNrofSCells) ) OF SCellCandidateConfig |
| OPTIONAL, -- Need N | |
| } | |
| SCellCandidateConfig::= | SEQUENCE { |
| sCellCandIndex | SCellIndex, |
| sCellConfigCommon | ServingCellConfigCommon |
| OPTIONAL, --Cond SCellAdd | |
| sCellConfigDedicated | ServingCellConfig |
| OPTIONAL, -- Cond SCellAddMod | |
| [...] | |
| } | |

In the case candidate cells that can be an SCell via L1 mobility (e.g. one of the cells in sCellCandidates ToAddModList) may include UE-specific configuration, which may include TCI state configurations (or CSI configurations), the use of current systems (e.g. prior art) for the MAC CE design for TCI state indication may be ambiguous. The UE needs to be able to determine in which cell configuration it should find a certain TCI state configuration that is being indicated with the MAC CE and, the current interpretation of Serving Cell ID says that the field indicates the identity of the Serving Cell for which the MAC CE applies. However, if in a given serving frequency, there can be more than one cell with a TCI state configuration, it is not clear which configuration (i.e. the configuration of which cell) the UE should consider for the TCI state. There could be different solutions for that:

In one example, the UE assumes that the Serving Cell ID field in the MAC CE indicates the current cell the UE considers as SCell in the serving frequency indicated by the Serving Cell ID. That may be the initial SCell or any candidate cell that has become the SCell (via L1 mobility).

In a second example, the UE assumes that the Serving Cell ID field in the MAC CE indicates the configuration of the initial SCell.

In a third example, the UE assumes that the Serving Cell ID field in the MAC CE indicates the serving frequency, and an additional identifier in the same MAC CE indicates the candidate cell in that serving frequency where the TCI state is configured.

In a fourth example, the UE assumes that the Serving Cell ID field in the MAC CE indicates the candidate cell in a serving frequency where the TCI state is configured, and an additional identifier (e.g. Serving Frequency ID) is included in the MAC CE to indicate the serving frequency where that candidate cell is configured. FIG. 7 illustrates such an example.

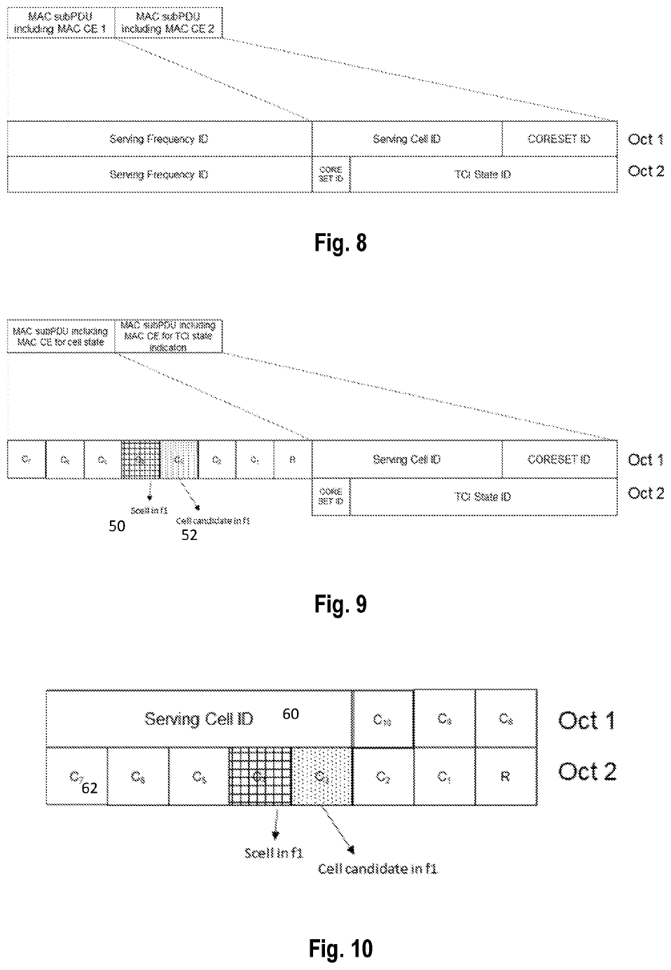

In a fifth example, the UE receives an initial MAC CE of a second type to indicate the serving frequency (for an SCell) the UE considers to locate the candidate cells and its configurations: that may correspond to a MAC subPDU including a MAC CE 1, where the MAC CE 1 contains the Serving Frequency ID that corresponds to the serving cell index configured in SCellConfig (e.g. sCellIndex). A MAC CE for the TCI state indication, including the Serving Cell ID, to indicate in which candidate cell (within the indicated serving frequency) is the TCI configuration being indicated, may correspond to a MAC subPDU including MAC CE 2. The two MAC subPDUs can be received by the UE (transmitted by the network) in the same MAC PDU. FIG. 8 illustrates such an example.

Some additional options related to any of the previous examples are described now. In a first version/option, the MAC CE does not contain the coreset ID, but the BWP ID and the same TCI state are updated to all CORESETs of the indicated BWP. In another option, the MAC CE does not contain the BWP ID nor the CORESET ID, but the same TCI state is applied to all CORESETs in all BWPs of the indicated Scell. In yet another option, the MAC CE does not contain the BWP ID nor the CORESET ID, but it contains a list of TCI states which give the TCI states for CORESETs configured in all BWPs. In this case, the order of TCI states mapping to CORESETs is fixed, e.g. the mapping starts from CORESETs configured for BWP ID 1 and then CORESETs configured for BWP ID 2 and so on. Note that in these examples/options, the MAC CE may also include additional fields indicating the form of the MAC CE. For example, a n bit field (e.g. field F) may indicate which of the possible forms the MAC CE is configured with. That is, e.g. whether it contains a list of TCI states or whether there is BWP ID and so on.

In any of the cases and examples described above, upon reception of the MAC CE for L1 mobility for an SCell, the UE determines a new candidate cell that is to become the SCell in that serving frequency, which can be considered as a change of SCell. Details regarding UE actions upon changing SCell (i.e. change the SCell in a given serving frequency from the first cell to the second cell) will be described now.

UE Actions Upon Changing an SCell with L1 Mobility

As mentioned above, the UE “changing” the SCell in the first frequency from the first cell to the second cell (also in the first frequency) does not exist as a procedure in the NR or LTE specifications. Hence, actions corresponding to this “changing” are defined as part of the method, such as one of the following, or any combinations of the following:

A) Set the SCell State of the First Cell and/or the State of the Second Cell

In some embodiments, the state of the initial SCell is set via RRC and can be deactivated, activated or dormant.

For example, upon changing the SCell from a first cell to a second cell, the UE sets the SCell state of the first cell and/or sets the state of the second cell (the one that becomes the Scell in that serving frequency), according to rule(s) and/or RRC configuration and/or indications received in MAC CEs.

In one embodiment, the UE sets the state of the first cell to deactivated, suspended (new state defined later) or dormant, while the state of the second cell (that becomes the SCell in that serving frequency) is set to activated. This is done as a UE autonomous action upon reception of the MAC CE for L1 mobility upon the UE determining the change from the first cell to the second cell.

In another embodiment, the UE sets the state of the first cell to a new state (e.g. suspended), meaning that the UE does not perform lower layer procedures for that cell (e.g. no CSI measurements, no CSI reporting, no PDCCH monitoring, no PUCCH/PUSCH transmissions, no RACH, etc.), except if in some other cell's configuration, CSI measurements are configured for that suspended cell. That cell is simply a cell whose configuration is stored in the UE's RRC configuration and may be activated at any point in time, e.g. by RRC or MAC CE.

In one embodiment, the state of the second cell is set to a value configured via RRC (e.g. activated) to be set when the second cell (configured as a candidate) is indicated to be the SCell via the reception of the L1/L2 signaling, like a MAC CE for L1 based mobility, where the MAC CE indicates a TCI state whose QCL source has an RS of the second cell. This is done as a UE autonomous action upon reception of the MAC CE for L1 mobility upon the UE determining the change from the first cell to the second cell, based on stored RRC configurations for the first and second cells. In one example, this embodiment is applicable in the case the candidate cells for L1/L2 mobility in the first frequency are configured as SCells, such as the second cell. Then, according to the method, “changing” an SCell may be equivalent to deactivate the first SCell (or move it to dormant state) and activate the second SCell.

A first example of how that may be implemented in the MAC specifications (TS 38.321) is shown below. In this example, the actions for activation/deactivation of an SCell upon SCell change are performed as part of the procedure upon reception of the MAC CE for L1 mobility of an SCell, as follows:

```
*****************************************************************************************************************
5.18.5 Indication of TCI state for UE-specific PDCCH
The network may indicate a TCI state for PDCCH reception for a CORESET of a Serving Cell or a set of Serving
Cells configured in simultaneousTCI-UpdateList1 or simultaneousTCI-UpdateList2 or candidate cell for L1 mobility
in a serving frequency by sending the TCI State Indication for UE-specific PDCCH MAC CE described in clause
6.1.3.15.
The MAC entity shall:
  1> if the MAC entity receives a TCI State Indication for UE-specific PDCCH MAC CE on a Serving Cell:
    2> indicate to lower layers the information regarding the TCI State Indication for UE-specific PDCCH MAC
      CE
    2> if the indicated TCI State ID has a QCL source whose RS is in a candidate cell in a serving
      frequency that is not the SCell in that serving frequency:
      3> suspend the SCell;
      3> consider the candidate cell as the SCell in that serving frequency;
      3> if the candidate cell is configured with sCellStateUponChange set to activated:
        4> perform actions upon SCell activation, as defined in clause 5.9 (Activation/Deactivation of
          SCells);
      3> if the candidate cell is configured with sCellStateUponChange set to deactivated:
        4> perform actions upon SCell deactivation, as defined in clause 5.9
            (Activation/Deactivation of SCells);
*****************************************************************************************************************
```

A second example of how that may be implemented in the MAC specifications (TS 38.321) is shown below, where upon receiving the indication of which TCI state is being indicated, the lower layers determine that the new TCI state has as QCL source a RS of a different cell (second cell) than the SCell in that serving frequency and indicates the new SCell to the upper layers so that the MAC entity performs actions according to the SCell change, as follows:

```
*****************************************************************************************************************
5.18.5 Indication of TCI state for UE-specific PDCCH
[...]
The MAC entity shall:
  1> if the MAC entity receives a TCI State Indication for UE-specific PDCCH MAC CE on a Serving Cell:
    2> indicate to lower layers the information regarding the TCI State Indication for UE-specific PDCCH MAC
      CE.
The MAC entity shall:
  1> upon receiving an indication from lower layers of an SCell change to a configured candidate cell in a
    serving frequency:
    2> suspend the SCell;
    2> consider the candidate cell as the SCell in that serving frequency:
    2> if the candidate cell is configured with sCellStateUponChange set to activated:
      3> perform actions upon SCell activation, as defined in clause 5.9 (Activation/Deactivation of
        SCells);
    3> if the candidate cell is configured with sCellStateUponChange set to deactivated:
      4> perform actions upon SCell deactivation, as defined in clause 5.9 (Activation/Deactivation of
        SCells);
*****************************************************************************************************************
```

In some embodiments, the UE receives an explicit indication that the first cell (i.e. the SCell in the first frequency) is to be set to a first state (e.g. deactivated or suspended) and an indication that the second cell is to be set to a second state (e.g. activated), where the first cell can be the SCell in the first frequency and the second cell can be a candidate cell for L1 mobility (in the same serving frequency). As described above, there could be different ways to identify which cells (the SCell or a candidate cell) in a given serving frequency the UE shall set the state according to the received indication(s).

In one embodiment, the UE receives both cell state indications included in a MAC CE of a first type, for setting cell states. If the UE has been configured with a single list of cells (initial SCell and candidate cells), and a common pool of cell indexes/identifiers is used (e.g. as described in the “Common list for cells in all Scell serving frequencies”), the MAC CE of a first type may refer to the index of the first cell to indicate the state the UE shall set for the first cell, and it may refer to the index of the second cell to indicate the state the UE shall set for the second cell. The MAC CE of the first type can be multiplexed with a MAC CE of the second type (for a TCI state indication), so that the UE can receive in the same MAC PDU, a MAC CE of the first type and a MAC CE of the second type. The MAC CE of the second type is used to indicate a TCI state ID for a configured TCI state with a QCL configured with a RS of the second cell, where the second cell in a serving frequency is not the SCell).

In the example shown in FIG. 9, the SCell in the first serving frequency (f1) is the cell 50 whose serving cell index is set to 4 (configured sCellIndex=4) and the candidate cell 52 is the one whose index is set to 3 (configured sCellIndex=3). Ci indicates that if there is an SCell configured for the MAC entity or a candidate cell in a serving frequency of the SCell with SCellIndex i, this field indicates the activation/deactivation status of the SCell or of the candidate cell with SCellIndex i, else the MAC entity shall ignore the Ci field. The Ci field is set to 1 to indicate that the SCell with SCellIndex i shall be activated. The Ci field is set to 0 to indicate that the SCell with SCellIndex i shall be deactivated.

In another embodiment, if the initial SCell and candidate cells to be SCells in L1 mobility are configured as described in the “list per serving frequency (for an SCell)”, in the RRC configuration (SCellConfig), if L1 mobility is configured for SCells, a first index/identifier is used to indicate the serving frequency (sCellIndex) while a second index is used to indicate a cell within that serving frequency (sCellCandIndex), which may be the initial SCell and/or a candidate cell (to be SCell via L1 mobility). Then, under this kind of configuration, the MAC CE of the first type may lead to ambiguities concerning the cell state the UE shall set (except in case there is a serving frequency where there is a single cell configured, and that is the SCell). To resolve this ambiguity, one of the alternatives can be considered (instead of considering a MAC CE of the first type):

In one alternative, the UE receives in the same MAC PDU, a MAC CE of the first type and a MAC CE of the second type, where in the MAC CE of the second type it is indicated a TCI state ID for a configured TCI state with a QCL configured with a RS of the second cell, where the cell in a serving frequency is not the SCell. Then, upon processing the MAC CE of the second type and receiving the Serving Cell ID, the UE determines to which candidate cells and/or Scells the MAC CE of the first type, received in the same MAC PDU, is referring. In other words, the MAC CE of the first type, if indicating a SCell change, also indicates the serving frequency for the SCell/candidate cells of the MAC CE of the first type.

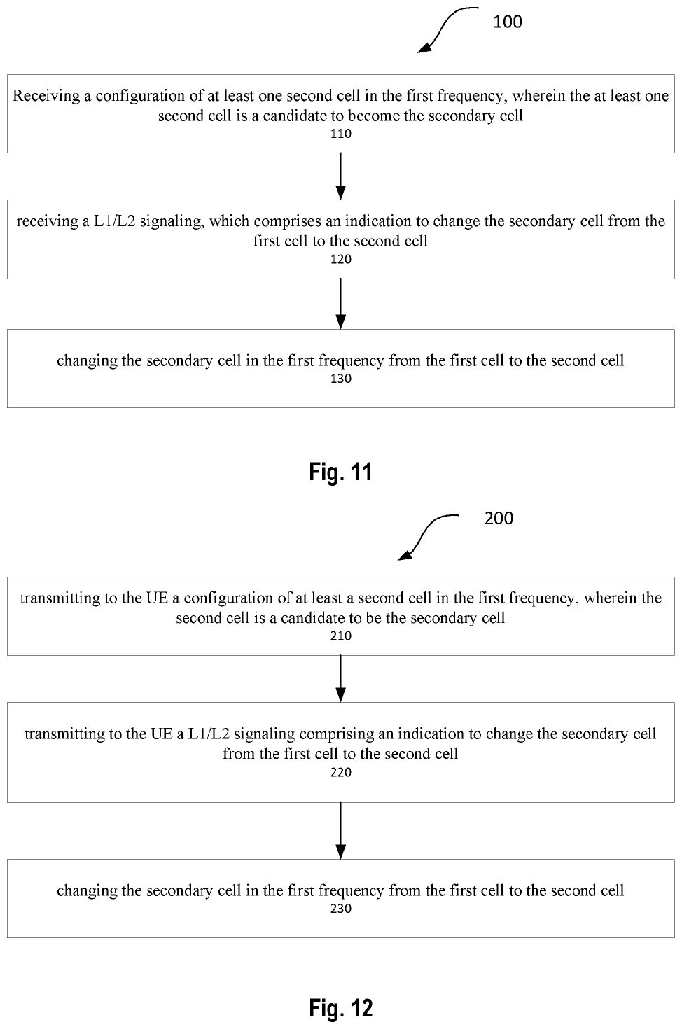

In another alternative, a new MAC CE of the first type is defined (possibly having its own logical channel identity/identifier as defined in a table in TS 38.321). An example of the new MAC CE is illustrated in FIG. 10 and may comprise:
a Serving Cell ID field 60, to indicate the serving frequency upon which the UE determines that this is setting the state(s) of SCell and/or candidate cell(s) in that serving frequency (i.e. the one whose sCellIndex is indicated by the Serving Cell ID received in the MAC CE) and
an indication per cell, indicating the state the UE shall set per cell upon the reception of the MAC CE. In one example, that is a field Ci 62: if there is an SCell or a candidate cell configured for the MAC entity for the serving frequency indicated by the Serving Cell ID, with SCellIndex i, this field indicates the activation/deactivation status of the SCell or the candidate cell with SCellIndex i in that serving frequency, else the MAC entity shall ignore the Ci field. The Ci field is set to 1 to indicate that the SCell with SCellIndex i shall be activated. The Ci field is set to 0 to indicate that the SCell with SCellIndex i shall be deactivated (or suspended). The example MAC CE of FIG. 10 shows up to 11 candidate cells for a given serving frequency that could have their states set with the reception of the MAC CE.

It should be noted that any of the previous examples/embodiments shown for the MAC CE of the second type (for TCI state indication with SCell change) are also applicable in this section (“UE actions upon changing an SCell with L1 mobility”).

Actions (Performed by the UE) Related to the Cell State that is Set

Different actions on the first cell and on the second cell can be performed, depending on the SCell state that is set to an SCell and/or to a candidate cell that becomes the SCell via L1 mobility.

When a candidate cell becomes the SCell (via L1 mobility) and the SCell state (for the initial Scell/first cell) is set to deactivated, at least one of the following actions (or a combination of these actions are performed), in which the SCell refers to the first cell:
deactivate the SCell according to the timing defined in TS 38.213:
stop the SCell deactivation timer (e.g. sCellDeactivationTimer) associated with the SCell:
stop the bwp-Inactivity Timer associated with the SCell;
deactivate any active BWP associated with the SCell:
clear any configured downlink assignment and any configured uplink grant Type 2 associated with the SCell respectively:
clear any PUSCH resource for semi-persistent CSI reporting associated with the SCell:
suspend any configured uplink grant Type 1 associated with the SCell;
flush all HARQ buffers associated with the SCell;
cancel, if any, triggered consistent LBT failure for the SCell.
stop transmitting SRS on the SCell:
stop reporting CSI for the SCell:
stop transmitting on UL-SCH on the SCell:
stop performing transmissions on RACH on the SCell;
stop monitoring the PDCCH on the SCell;
stop transmitting PUCCH on the SCell.
indicate to the UE's higher layers about the change in the SCell, thus resulting in at least one of the following actions:
   change in the RRM measurements associated to the serving cell on that frequency. For example, the UE considers the newly indicated cell the serving cell in that frequency in order to perform serving cell measurements (as defined in TS 38.331, 5.5).
   change in the RRM measurements associated to the candidate serving cells on that frequency.
   resetting of any ongoing event evaluation on that frequency based on the previous serving cell on that frequency.
   resetting of any ongoing event evaluation on that frequency based on the previous candidate cell that became the serving cell on that frequency.

When the first cell the UE is changing from (the SCell in the first frequency before the second cell becomes the SCell in the first frequency) is set to suspended (via L1 mobility), a very limited set of actions are performed. Hence, the UE stops performing actions in the deactivated state, but in addition, the UE performs the following:
the UE stops performing RRM measurements on the first cell (that is being suspended) (except if a specific RRM configuration indicates otherwise), because there is a new SCell in that same serving frequency.
the UE stops performing CSI measurement/reporting according to the first cell's configuration, but it may perform CSI measurements on RS(s) of the first cell (if configured to be performed, e.g. in another configured cell that is not suspended, such as the second cell).
in case the UE is configured with a UE-specific configuration per serving frequency (where CSI is configured) that is not suspended, as that is valid regardless of which cell is the SCell in that frequency.
in one example, when the first cell is suspended, it means that its configuration is stored (e.g. ServingCellConfigCommon) but the UE does not do anything related to it, unless that is later resumed (e.g. by setting the state of that cell to deactivated, dormant or activated). That suspension of a cell candidate may not lead to UE actions based on UE-specific configurations, if the candidate cells mainly comprises cell-specific configurations (as described in “List per serving frequency (for an SCell)”).

When a candidate cell becomes an SCell (via L1 mobility) and the SCell state is set to activated, at least one of the following actions (or a combination of these actions are performed), where the SCell is the candidate cell: SRS transmissions on the SCell: CSI reporting for the SCell; PDCCH monitoring on the SCell: and/or PUCCH transmissions on the SCell, if configured.

### B) Handling of Deactivation Timer(s)

In legacy, the UE can be configured with an SCell deactivation timer (denoted sCellDeactivation Timer in TS 38.33), which is configured in the IE ServingCellConfig, which is configured for an SCell, in the UE-specific/dedicated part (i.e. it is not a cell specific configuration). The timer in legacy is started when a cell is activated.

New behaviors of this timer are introduced in this disclosure.

In one example, the timer is defined per serving frequency and not per serving cell, e.g. in case the UE is configured with multiple cells (initial SCell and candidate cells) in the same serving frequency.

In another example, the UE starts the timer upon being configured with an initial SCell whose state is set to activated.

In another example, the UE starts or restarts the timer (sCellDeactivationTimer) upon the reception of the MAC CE for L1 mobility for a candidate cell in that serving frequency.

### C) Handling of Cell-Specific Configurations and UE-Specific Configurations

As described above, there may be different cell configurations for the initial SCell and the candidate Cell(s), in a given serving frequency. The following approaches are considered:

Approach i) UE-specific configurations are frequency-specific: and the initial SCell and each candidate cell in a serving frequency have their own cell-specific configuration.

Approach ii) UE-specific configurations are defined per cell in the serving frequency; and the initial SCell and each candidate cell in a serving frequency have their own UE-specific configurations and their own cell-specific configuration.

For approach i), the configuration of candidate cells for L1 mobility to be changed to SCell(s) may be limited to cell-specific configuration(s) such as information in the IE ServingCellConfigCommon, including the PCI. In this case, a change of SCell in the serving frequency f1 (whose serving frequency index is sCellIndex=1) from the SCell whose sCellCandIndex=3 to the SCell whose sCellCandIndex=5 leads the UE to stop using the ServingCellConfigCommon associated to sCellCandIndex=3, to start using the ServingCellConfigCommon associated to sCellCandIndex=5. That means, for example, that the PCI to be considered the SCell's PCI is the one in the new ServingCellConfigCommon, which may be needed in case the UE performs RRM measurements for the SCell. Hence, upon “SCell change” via L1 mobility, the UE remains with its valid UE-specific configuration(s), i.e. sCellConfigDedicated of IE ServingCellConfig remains the same, while a new sCellConfigCommon (the one for the cell candidate that becomes the SCell) starts to be used. As the UE-specific configurations remain the same, which contains the CSI configurations for the UE to perform measurements not only in the initial SCell but in the candidates in that serving frequency, as well as the TCI state configurations whose QCL source may refer to RS on the initial SCell or/and any configured candidate cell (e.g. in that serving frequency).

For approach ii), in addition to the change of cell-specific configurations, upon SCell change, the UE also changes its UE-dedicated configurations. In this case, a change of SCell in the serving frequency f1 (whose serving frequency index is sCellIndex=1) from the SCell whose sCellCandIndex=3 to the SCell whose sCellCandIndex=5 leads the UE to stop using the sCellConfigDedicated of IE ServingCellConfig associated to sCellCandIndex=3, to start using the sCellConfigDedicated of IE ServingCellConfig associated to sCellCandIndex=5. That means, for example, that a new set of TCI state configurations can be applied, and/or a new set of CSI configurations can be applied. Hence, upon “SCell change” via L1 mobility, the UE can update/modify/add/release UE-specific configuration(s).

In any of the approaches, there could be different ways to handle the changes in configuration(s) upon SCell change, such as at least one of the following schemes:
Delta signaling on top of the latest configuration: in this first scheme, the UE applies the new configuration (e.g. UE-specific, like sCellConfigDedicated of IE ServingCellConfig) on top of the previous configuration of the same type (like sCellConfigDedicated). As there may be changes from different pairs of candidate cells, e.g. cell-A to cell-B, cell-A to cell-C, cell-C to cell-A, there may be different versions of configurations to be applied depending on the current UE configuration.
Delta signaling on top of a reference configuration: in this second scheme, the UE applies the new configuration (e.g. UE-specific, like sCellConfigDedicated of IE ServingCellConfig) on top of a reference configuration of the same type, such as the equivalent configuration for the initial SCell (like sCellConfigDedicated). For example, upon SCell change, the UE first considers the configuration of the initial SCell and applies the new configuration (of the candidate cell that becomes the SCell) on top of that reference configuration, then it starts to operate according to the new applied configuration.
Configuration replacement: in this third scheme, the UE replaces with the new configuration (e.g. UE-specific, like sCellConfigDedicated of IE ServingCellConfig) the previous configuration. That requires more signaling than the previous options/schemes, but it may be simpler for the UE.

The disclosure also comprises a method implemented in a network entity/node, such as an NG-RAN function for handling the L1/L2 mobility for SCell(s) associated to a cell group of a UE served by the NG-RAN, the network node having configured the UE with a first cell as the SCell in a first frequency. For example, the network node may transmit to the UE configurations of at least a second cell in the first frequency, wherein the second cell is a candidate to be the SCell (e.g. via L1/L2 centric mobility). The network node may transmit to the UE a L1/L2 signaling, such as a MAC CE, indicating a change of cells for the Scell (through a TCI state whose QCL source has a RS of the second cell). Then, the network node can “change” the SCell in the first frequency from the first cell to the second cell for that UE.

In other words, as in the case of the UE, the network node also stops considering the first cell in the first frequency as the SCell and starts to consider the second cell as the SCell in the first frequency. Furthermore, the network node may configure the UE with cells in SCell frequencies (i.e. in serving frequencies that are not the SpCell frequency) that are candidates for L1-based mobility (such as the second cell) and different ways to index/identify these cells, e.g. an index associated to the cell group and/or the serving frequency.

The network node “changing” the SCell in the first frequency from the first cell to the second cell (also in the first frequency) does not exist as a procedure in the NR or LTE specifications. Hence, actions corresponding to this “change” are defined as part of the method, such as the ones defined for the UE. It should be noted that the embodiments that have been described with regards to the UE can be also applied to the method at the network node or to the actions performed by the network node.

FIG. 11 illustrates a flow chart of a method 100 in a UE/wireless device for handling L1/L2 mobility for secondary cells (Scells) associated with a cell group, where the UE is configured with a first cell as the secondary cell in a first frequency. Method 100 may comprise:

Step 110: receiving a configuration of at least one second cell in the first frequency, wherein the at least one second cell is a candidate to become the secondary cell:

Step 120: receiving a L1/L2 signaling, which comprises an indication to change the secondary cell from the first cell to the second cell: and

Step 130: changing the secondary cell in the first frequency from the first cell to the second cell.

For example, the indication to change the Scell from the first cell to the second cell may comprise a first TCI state whose QCL source has a RS of the second cell. And the received signal (L1/L2 signaling) can be a MAC CE or DCI.

In one example, the UE is configured with multiple cells in the first frequency, the multiple cells having different indexes. The first cell can be indicated as an initial Scell (using a parameter or choosing the smallest index). For example, the at least one second cell and the first cell can be identified by indexes.

In some examples, the configuration can be received in a RRC signaling (there may be one or more configurations). The RRC signaling may comprise a list of second cells associated with the first frequency. The list of second cells may also comprise cells associated with the first frequency and cells associated with a second frequency. For example, the first frequency can be the serving frequency.

In some examples, the configuration may comprise indications to configure the list of second cells to be in a deactivated state.

In some examples, the indication to change the Scell from the first cell to the second cell is an indication of a TCI state whose QCL source has a RS of the second cell.

In some examples, changing the Scell in the first frequency from the first cell to the second cell can be done by setting a state of the first cell to deactivated or suspended or dormant, and setting a state of the second cell to activated.

In some examples, the UE can receive one or more MAC CEs indicating setting the first cell to deactivated or suspended or dormant and indicating setting the second cell to activated.

In some examples, setting the state of the first cell to deactivated or suspended or dormant may comprise performing one or more of: stopping a deactivation timer, stopping transmitting SRS on the Scell, stopping reporting CSI for the Scell, stopping performing transmit on RACH on the SCell, stopping monitoring the PDCCH on the SCell, stopping monitoring the PDCCH for the SCell, stopping transmitting PUCCH on the SCell, stopping performing RRM measurements, etc.

In some examples, setting the state of the second cell to activated may comprise performing one or more of: SRS transmissions on the SCell, CSI reporting for the SCell, PDCCH monitoring on the SCell, PDCCH monitoring for the SCell, PUCCH transmissions on the SCell, if configured, etc.

In some examples, the UE may start a timer associated with the secondary cell when the UE is configured with the first cell. Or the UE can start or restart a timer associated with the secondary cell when the UE receives the L1/L2 signaling.

In some examples, changing the secondary cell in the first frequency from the first cell to the second cell may comprise applying a configuration associated with the second cell on top of a configuration associated with the first cell, or, applying a configuration associated with the second cell on top of a reference configuration, or, replacing a configuration associated with the first cell with a configuration associated with the second cell.

This disclosure may also comprise a method in a UE, which comprises: receiving a beam configuration associated with a physical channel: receiving a L1/L2 signaling (e.g. MAC CE) including an indication of a beam and a cell associated with the beam: and in response to determining that the cell associated with the indicated beam is in a serving frequency but the cell is not a serving cell, performing a change of serving cell from a current serving cell to the cell associated with the indicated beam.

Furthermore, this disclosure may also comprise a method in a UE, which comprises: receiving a MAC CE indicating a TCI state: determining that the indicated TCI state has a QCL source whose RS is in a candidate cell in the serving frequency that is not the SCell in that serving frequency: suspending the Scell (e.g. first cell); and considering the candidate cell as the Scell in that serving frequency.

Now turning to FIG. 12, a flow chart of a method 200 performed by a network node for handling L1/L2 mobility for secondary cells (Scells) associated with a cell group of a UE being configured with a first cell as a secondary cell in a first frequency will be described. The method may comprise:

Step 210: transmitting to the UE a configuration of at least a second cell in the first frequency, wherein the second cell is a candidate to be the secondary cell:

Step 220: transmitting to the UE a L1/L2 signaling, which comprises an indication to change the secondary cell from the first cell to the second cell; and

Step 230: changing the secondary cell in the first frequency from the first cell to the second cell.

In some examples, the configuration can be transmitted in a RRC signaling.

In some examples, the configuration comprises a list of second cells. For example, the list of second cells can comprise cells associated with the first frequency and cells associated with a second frequency or just cells associated with the first frequency. The first frequency can be the serving frequency. There may be one or more transmitted configurations.

In some examples, the configuration can comprise indications to configure the list of second cells to be in a deactivated state.

In some examples, the at least one second cell and the first cell can be identified by indexes. Further, the first cell can be identified as an initial cell for the secondary cell.

In some examples, the L1/L2 signaling is a MAC CE or DCI.

In some examples, the indication to change the secondary cell from the first cell to the second cell can be an indication of a TCI state whose QCL source has a RS of the second cell.

In some examples, changing the Scell in the first frequency from the first cell to the second cell may comprise setting a state of the first cell to deactivated or suspended or dormant, and setting a state of the second cell to activated.

In some examples, the network node may transmit one or more MAC CEs indicating setting the first cell to deactivated or suspended or dormant and indicating setting the second cell to activated.

In some examples, setting the state of the first cell to deactivated or suspended or dormant comprises performing one or more of: stopping receiving SRSs on the first cell, stopping receiving CSI for the first cell, stopping receiving on RACH on the first cell, stopping receiving on a PUCCH on the first cell and stopping performing RRM measurements.

In some examples, setting the state of the second cell to activated comprises performing one or more of: receiving SRS transmissions on the second cell, receiving CSI reports for the second cell, receiving PUCCH transmissions on the second cell.

In some examples, changing the secondary cell in the first frequency from the first cell to the second cell may comprise applying a configuration associated with the second cell on top of a configuration associated with the first cell, or, applying a configuration associated with the second cell on top of a reference configuration, or, replacing a configuration associated with the first cell with a configuration associated with the second cell.

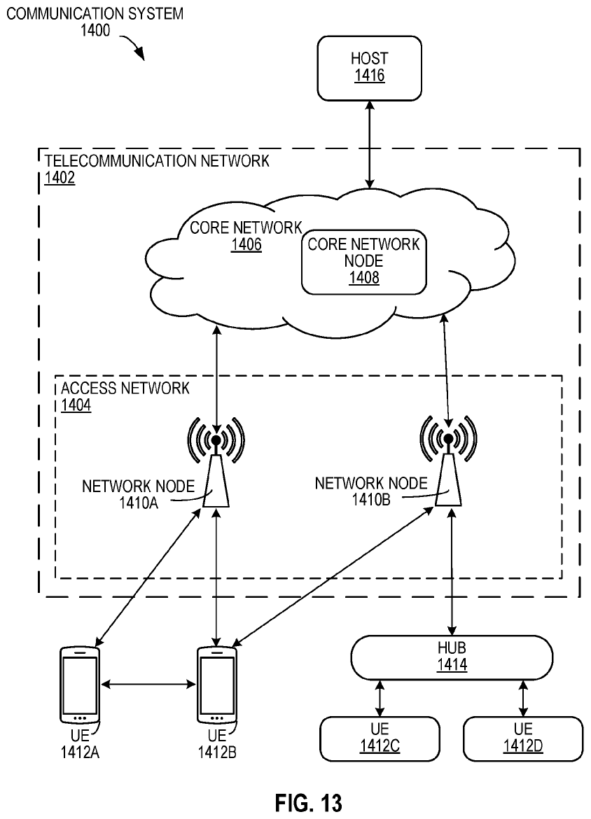

FIG. 13 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3rd Generation Partnership Project (3GPP) access node or non-3GPP access point. The network nodes 1410 facilitate direct or indirect connection of UE, such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

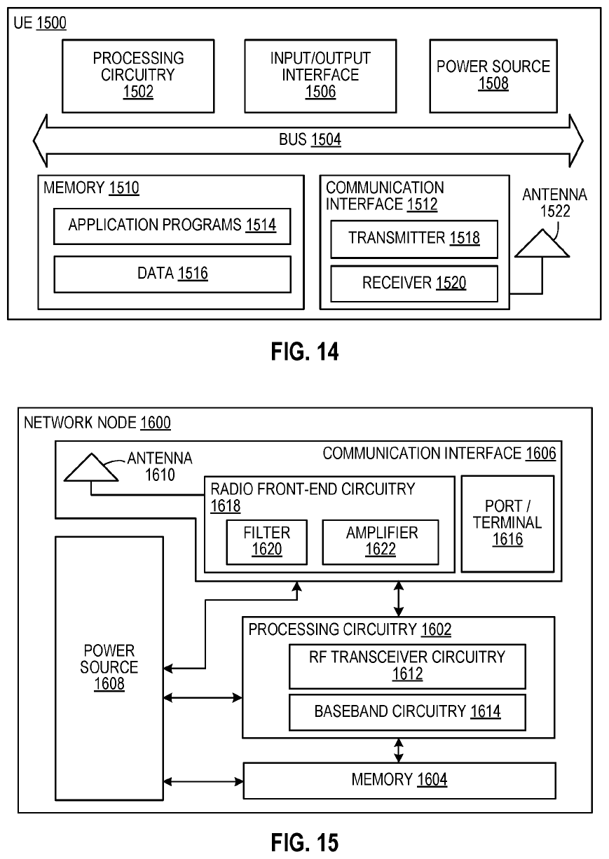

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or 4G, 5G standards, or any applicable future generation standard (e.g., 6G): wireless local area network (WLAN) standards, such as the Institute of Electrical and Electronics Engineers (IEEE) 802.11 standards (WiFi): and/or Worldwide Interoperability for Microwave Access (WiMax), Bluetooth, Z-Wave, Near Field Communication (NFC) ZigBee, LiFi, and/or any low-power wide-area network (LPWAN).

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b.

FIG. 14 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware: one or more stored computer programs, general-purpose processors, such as a microprocessor or digital signal processor (DSP), together with appropriate software: or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately. Further, the processing circuitry 1502 can be configured to perform any of the steps of method 100 of FIG. 11.

In the illustrated embodiment, communication functions of the communication interface 1512 may include cellular/Wi-Fi/LPWAN/data/voice/multimedia/short-range (Bluetooth)/near-field communications, and location-based communication such as the use of the global positioning system (GPS) to determine a location, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change.

A UE, when in the form of an Internet of Things (IOT) device, may be a device for use in one or more application domains, such as city wearable technology, extended industrial application and healthcare. Non-limiting examples of such an IoT device are a device which is or which is embedded in: a connected refrigerator a TV, a connected lighting device, an electricity meter, a robot vacuum cleaner, a smart watch, a fitness tracker, a head-mounted display for Augmented Reality (AR) or Virtual Reality, a heart rate monitor or a remote controlled surgical robot. A UE in the form of an IoT device comprises circuitry and/or software in dependence of the intended application of the IoT device in addition to other components as described in relation to the UE 1500 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device or a MTC device. The UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone.

FIG. 15 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the RF transceiver circuitry 1612 and the baseband processing circuitry 1614 may be on separate chips (or sets of chips), boards, or units, such as radio units and digital units. In some embodiments, part or all of RF transceiver circuitry 1612 and baseband processing circuitry 1614 may be on the same chip or set of chips, boards, or units. Further, the processing circuitry 1602 may be configured to perform any steps of method 200 of FIG. 12.

The memory 1604 may comprise any form of volatile or non-volatile computer-readable memory including, without limitation, persistent storage, solid-state memory, remotely mounted memory, magnetic media, optical media, RAM, ROM, mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 15 for providing certain aspects of the network node's functionality, including any of the functionality described herein and/or any functionality necessary to support the subject matter described herein.

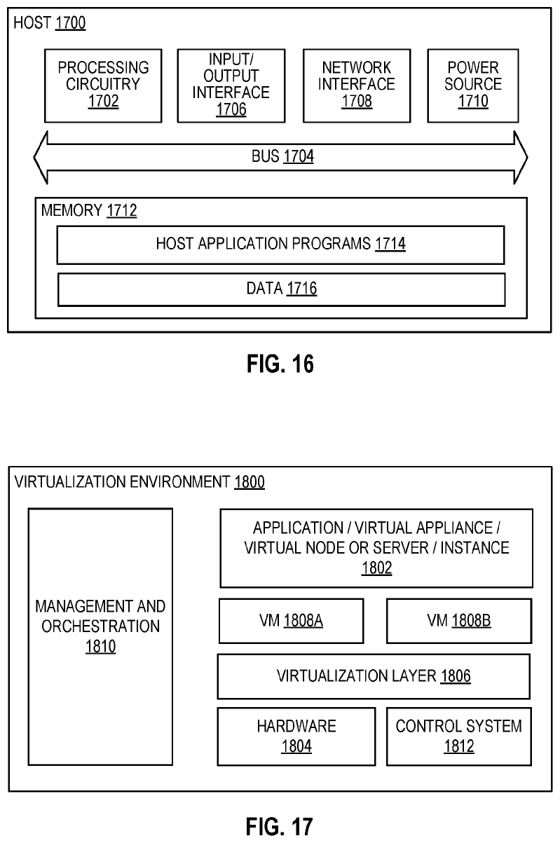

FIG. 16 is a block diagram of a host 1700, which may be an embodiment of the host 1416 of FIG. 13, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 14 and 15, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

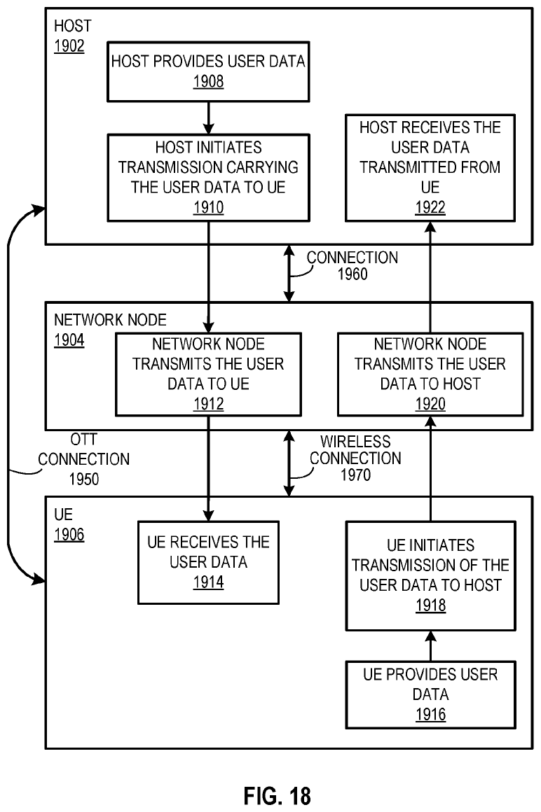

FIG. 18 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 13 and/or UE 1500 of FIG. 14), network node (such as network node 1410a of FIG. 13 and/or network node 1600 of FIG. 15), and host (such as host 1416 of FIG. 13 and/or host 1700 of FIG. 16) discussed in the preceding paragraphs will now be described with reference to FIG. 18.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve the data rate or latency and thereby provide benefits such reduced user waiting time and better responsiveness.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes: the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.: the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description, which is defined solely by the appended claims.

1. A method performed by a user equipment (UE) configured in Carrier Aggregation for handling Layer 1(L1)/Layer 2 (L2) mobility for secondary cells associated with a cell group, the UE being configured with a first cell as a secondary cell in a first frequency, the method comprising:
receiving a configuration of at least one second cell in the first frequency, wherein the at least one second cell is a candidate to become the secondary cell;
receiving a L1/L2 signaling, which comprises an indication to change the secondary cell from the first cell to the second cell; and
changing the secondary cell in the first frequency from the first cell to the second cell.

2. The method of claim 1, wherein receiving the configuration comprises receiving a Radio Resource Control (RRC) signaling.

3. The method of claim 1, wherein receiving the configuration comprises receiving a list of second cells.

4. The method of claim 3, wherein the list of second cells comprises cells associated with the first frequency and cells associated with a second frequency.

5. The method of claim 3, wherein the list of second cells comprises cells associated only with the first frequency.

6. The method of claim 3, wherein the configuration comprises an indication to configure the list of second cells to be in a deactivated state.

7. The method of claim 1, wherein the at least one second cell and the first cell are identified by indexes.

8. The method of claim 1, wherein the first cell is identified as an initial cell for the secondary cell.

9. The method of claim 1, wherein the L1/L2 signaling is a Medium Access Control (MAC) Control Element (CE).

10. The method of claim 1, wherein the L1/L2 signaling is a downlink Control Information (DCI) signaling.

11. The method of claim 1, wherein the indication to change the secondary cell from the first cell to the second cell is a Transmission Configuration Indicator (TCI) state whose quasi co-located (QCL) source has a Reference Signal (RS) associated with the second cell.

12. The method of claim 1, wherein changing the secondary cell in the first frequency from the first cell to the second cell comprises setting a state of the first cell to deactivated or suspended or dormant, and setting a state of the second cell to activated.

13. The method of claim 12, further comprising receiving one or more MAC CEs indicating setting the first cell to deactivated or suspended or dormant and indicating setting the second cell to activated.

14. (canceled)

15. (canceled)

16. (canceled)

17. The method of claim 1, further comprising starting or restarting a timer associated with the secondary cell when the UE receives the L1/L2 signaling.

18. The method of claim 1, wherein changing the secondary cell in the first frequency from the first cell to the second cell comprises applying a configuration associated with the second cell on top of a configuration associated with the first cell.

19. The method of claim 1, wherein changing the secondary cell in the first frequency from the first cell to the second cell comprises applying a configuration associated with the second cell on top of a reference configuration.

20. The method of claim 1, wherein changing the secondary cell in the first frequency from the first cell to the second cell comprises replacing a configuration associated with the first cell with a configuration associated with the second cell.

21. The method of claim 1, wherein the first frequency is a serving frequency of the UE.

22. A user equipment (UE) comprising processing circuitry and a network interface connected thereto, the processing circuitry configured to:
receive a configuration of at least one second cell in the first frequency, wherein the at least one second cell is a candidate to become the secondary cell;
receive a L1/L2 signaling, which comprises an indication to change the secondary cell from the first cell to the second cell; and
change the secondary cell in the first frequency from the first cell to the second cell.

23. A method performed by a network node for handling Layer 1 (L1)/Layer 2 (L2) mobility for secondary cells associated with a cell group for a user equipment (UE) being configured in carrier aggregation and with a first cell as a secondary cell in a first frequency, the method comprising:
transmitting to the UE a configuration of at least a second cell in the first frequency, wherein the second cell is a candidate to become the secondary cell;
transmitting to the UE a L1/L2 signaling, which comprises an indication to change the secondary cell from the first cell to the second cell; and
changing the secondary cell in the first frequency from the first cell to the second cell.

24-42. (canceled)
